(19) United States
(12) Patent Application Publication
(10) Pub. No.: US 2007/0080278 A1
(43) Pub. Date: Apr. 12, 2007

(54) Hanger for nail driver

(75) Inventor: Wan-Fu Wen, Taipei Hsien (TW)

Correspondence Address: Wen-Chin Hu, 4331 Stevens Battle Lane, Fairfax, VA, 22033, US

(73) Assignee: De Poan Pneumatic Corp.

(21) Appl. No.: 11/243,987

(22) Filed: Oct. 6, 2005

(51) Int. Cl. F16M 13/00

(52) U.S. Cl. 248/547

(57) ABSTRACT

A hanger for a nail driver includes a hoop element and a hook element. The hoop element is rotatably mounted on a circular seat of a tail part of the nail driver. The circular seat has at least one first engaging portion formed thereon. The hoop element has at least one second engaging portion formed on an inner circle thereof to engage with the first engaging portion. Thereby, the hoop element can be rotated with respect to the nail driver until the first and the second engaging portions are engaged to each other to provide an adjustable position of the hook for hanging on the nail driver.

### BACKGROUND OF THE INVENTION

The present invention relates to a hanger for a nail driver and in particular to an adjustable hanger mounted on a tail part of a nail driver for users to easily hang on the nail driver in different positions.

In order to reduce the burden for the weight of nail driver on the user at operation, the hanger is typically utilized for the nail driver conveniently to be hung on the waist or the shelf.

Conventionally, the hanger is fixedly installed on the nail driver for securely hanging purpose. However, the fixed hanger is not suitable for the user to hang on the nail driver in different positions.

Conventionally, there are some nail drivers equipped with a movable hanger. However, the movable hanger is free at any position so that the nail driver can not be stably hanged. Even other movable hanger may be adjusted to a fixed position, the structure may be too complicated so that the manufacturing cost may be high. Therefore, the conventional hanger for the nail driver has a need to be improved.

### BRIEF SUMMARY OF THE INVENTION

The present invention is to provide an adjustable hanger with a neat structure for a nail driver to hang on in different positions.

Accordingly, the hanger for the nail driver of the present invention includes a hoop element and a hook element The hoop element is rotatably mounted on a circular seat of a tail part of the nail driver. The circular seat has at least one first engaging portion formed thereon. The hoop element has at least one second engaging portion formed on an inner circle thereof to engage with the first engaging portion. Thereby, the hoop element can be rotated with respect to the nail driver until the first and the second engaging portions are engaged to each other to provide an adjustable position of the hook for hanging on the nail driver.

Various objects and advantages of the present invention will be more readily understood from the following detailed description when read in conjunction with the appended drawing.

### BRIEF DESCRIPTION OF THE DRAWINGS

FIG. 1 is an exploded perspective view of an adjustable hanger for a nail driver according to the present invention.

FIG. 2 is a cross sectional view of the hanger mounted on a tail part of the nail driver.

FIG. 3 is a cross sectional view along line 3-3 of FIG. 2, showing an engagement of hanger with the nail driver.

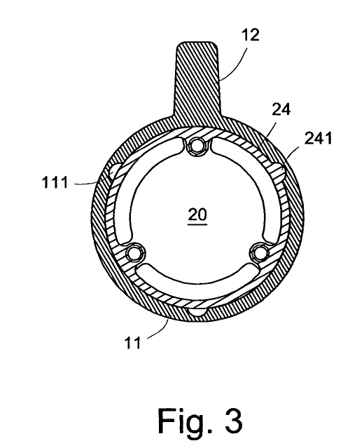

FIG. 4 shows the nail driver hanging on a shelf by the hanger of the present invention.

FIG. 5 is a cross sectional view of a hanger mounted on the tail part of the nail driver accordingly to another preferred embodiment. FIG. 6 is a cross sectional view of a hanger mounted on the tail part of the nail driver accordingly to still another preferred embodiment.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

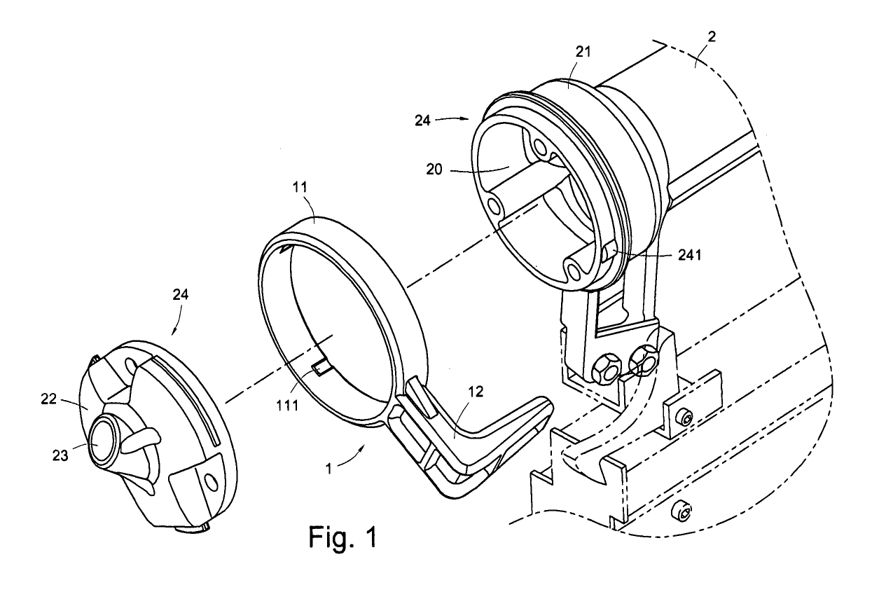

Referring to FIG. 1, an adjustable hanger 1 made of resilient flexible material for a nail driver 2 of the present invention includes a hoop element 11 and a hook element 12. The hoop element 11 is rotatably mounted on a circular seat 24 of a tail part of the nail driver 2.

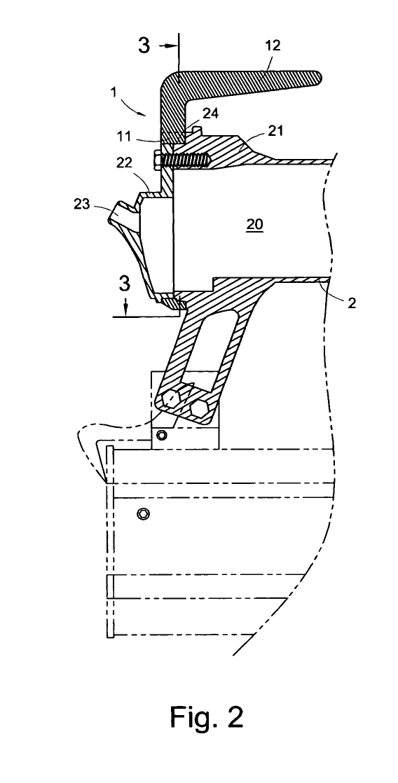

The nail driver 2 includes an airflow channel 20 formed inside, as shown in FIG. 2, for the pressurized air passing through. The tail part of the nail driver 2 includes a cover portion 22 to be mounted on an end portion 21 thereof. The cover portion 22 includes an air-inlet 23 connected to the airflow channel 20. The air-inlet 23 is formed on a front surface of the cover portion for installing an air adapter to provide the pressurized air.

As shown in FIG. 2, the circular seat 24 is formed on both the end portion 23 and the cover portion 22 of the tail part. The circular seat 24 has at least one first engaging portion such as a protrusion 241 formed thereon. Moreover, the hoop element 11 has at least one second engaging portion such as a recess 111 formed on an inner circle thereof to engage with the first engaging portion 241.

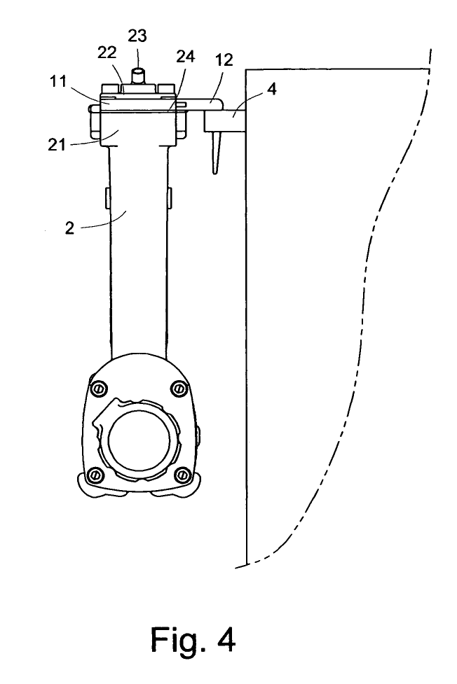

As such, the hoop element 11 can be rotated with respect to the nail driver 2 until the first and the second engaging portions 241 and 111 are engaged to each other to provide an adjustable position of the hook 12 for the nail driver 2 hanging on the waist of user or on the shelf 4 in different positions, as shown in FIG. 4.

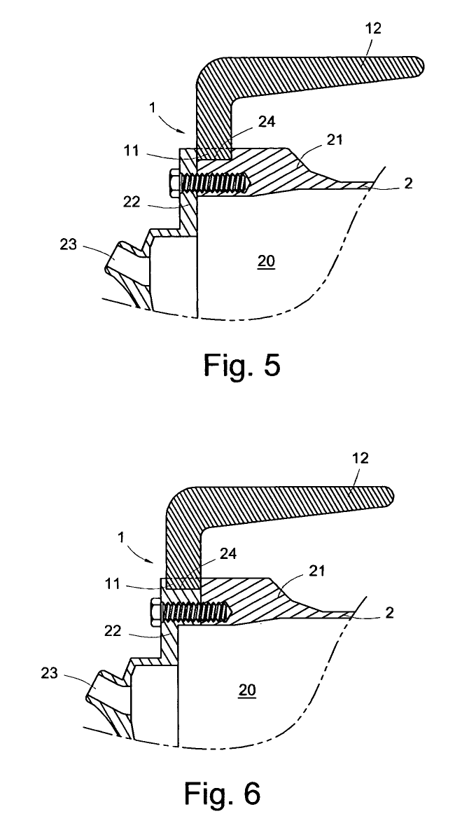

Furthermore, as shown in FIGS. 5 and 6, the circular seat 24 can be formed only on the end portion 21, or the circular seat 24 can be formed only on the cover portion 22 of the tail part of the nail driver 2, respectively.

The present invention is thus described. It will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A hanger for a nail driver, comprising:
a circular seat formed on a tail part of the nail driver, having at least one first engaging portion formed thereon;
a hoop element rotatably mounted on the circular seat, having at least one second engaging portion formed on an inner circle thereof to engage with the first engaging portion; and
a hook element extending from the hoop element, thereby, the hoop element is rotatable with respect to the nail driver until the first and the second engaging portions are engaged to each other to provide an adjustable position of the hook element for hanging on the nail driver.

2. The hanger as claimed in claim 1, wherein the circular seat is formed on an end portion and a cover portion of the tail part.

3. The hanger as claimed in claim 1, wherein the circular seat is formed only on an end portion of the tail part.

4. The hanger as claimed in claim 1, wherein the circular seat is formed only on a cover portion of the tail part.

5. The hanger as claimed in claim 1, wherein the first engaging portion is a protrusion and the second engaging portion is a recess.

6. The hanger as claimed in claim 1, wherein the first engaging portion is a recess and the second engaging portion is a protrusion.

7. The hanger as claimed in claim 1, wherein the hoop element is made of resilient flexible material.
